(19) United States
(12) Patent Application Publication
(10) Pub. No.: US 2012/0133777 A1
(43) Pub. Date: May 31, 2012

(54) CAMERA TRACKING WITH USER SCRIPT CONTROL

(75) Inventor: Charbel Khawand, Sammamish, WA (US)

(73) Assignee: Microsoft Corporation

(21) Appl. No.: 12/957,176

(22) Filed: Nov. 30, 2010

(51) Int. Cl. H04N 5/225

(52) U.S. Cl. 348/169

(57) ABSTRACT

The present application provides increased flexibility and control to a user by providing a camera and camera controller system that is responsive to a user-defined script. The user-defined script can allow a user to choose a subject and have the camera follow the subject automatically. In one embodiment, a camera is provided for taking still or video images. Movement of the camera is automatically controlled using a camera controller coupled to the camera. A user script is provided that describes a desired tracking of an object. The camera controller is responsive to the script for controlling the camera in order to track the object.

### FIELD

The present application relates to tracking images using a camera, and, particularly, to a system that can utilize user-generated scripts to control tracking.

### BACKGROUND

Automated photo and video camera tracking is known. For example, various devices and systems have been proposed for automatically tracking a position of a moveable object. Some systems, such as disclosed in U.S. Pat. No. 7,450,835, include a pendant to be worn by a user that communicates with a camera or tripod to assist with tracking. Other systems perform rudimentary tracking using built-in software. However, all such systems are notoriously difficult to train and calibrate. Additionally, user's have limited control over the tracking process.

### SUMMARY

The present application provides increased flexibility and control to a user by providing a camera and camera controller system that is responsive to a user-defined script. The user-defined script can allow a user to choose a subject and have the camera follow the subject automatically.

In one embodiment, a camera is provided for taking still or video images. Movement of the camera is automatically controlled using a camera controller coupled to the camera. A user script is provided that describes a desired tracking of an object. The camera controller is responsive to the script for controlling the camera in order to track the object.

In another embodiment, the camera controller can enter a learning mode wherein an object can be analyzed for future identification. A user can associate a name with the learned object and when the name is used in a script, the camera controller associates the name with the learned object and searches for the object in the current camera view.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flowchart of a method for automatically controlling camera movement in response to a user script.

FIG. 2 shows a high-level diagram with a camera coupled to an accessory used to track objects in a camera view.

FIG. 3 is a flowchart of a method for learning, naming and tracking an object.

FIG. 4 is a detailed flowchart of a method for learning and naming an object.

FIG. 5 is an embodiment showing hardware components used to implement a camera with a controller for tracking movement in response to a user-generated script.

FIG. 6 is an embodiment of a hardware circuit that can be used to control a stepper motor.

FIG. 7 is an example embodiment wherein a computing cloud is used to control a camera, wherein script generation and distribution is available on a wide-variety of hardware platforms.

### DETAILED DESCRIPTION

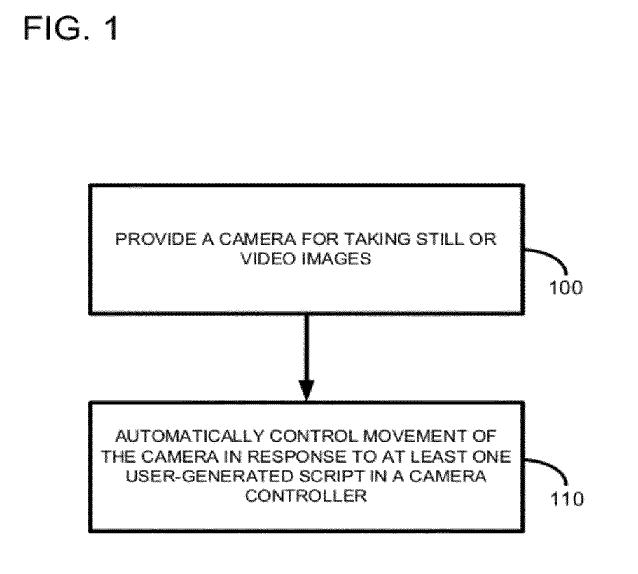

FIG. 1 is a flowchart of a method for automatically controlling camera movement in response to a user script. In process block 100, a camera is provided for taking still or video images. The camera is configured for communication with a camera controller, which can be positioned externally to the camera for controlling camera movement and other features on the camera, such as flash, zoom, image size, shutter speed, images per second, ACG, etc. In process block 110, the camera controller automatically controls movement of the camera in response to at least one user-generated script. Such movement can be through a stepper motor or other means. The camera controller can assist the camera in keeping a subject in focus during image capture, even as the subject is moving. In one example, the user can choose a subject and focus in on it manually using the camera. Control can then be passed to the camera controller to continue to track the subject on its own. Alternatively, the camera controller can be fully automated using predefined scripts that instruct the camera to search for a predefined object and track the object.

As further described below, the script can be any desired programming language, such as XML or other scripting languages. It is desirable that the language support some of the following instructions: identifying an object; learning and recognizing objects; using pre-learned objects; timer initiated actions; scene description syntax; video, still image and audio processing initiation; camera action initiation (zoom, focus, record, etc.); and camera translated user actions (detecting a wave to initiate an action). The programming language can be a combination of English syntax and camera specific actions, such as if, then, else, do, follow, track, stay, etc. for syntax and focus, zoom, flash on/off, etc.

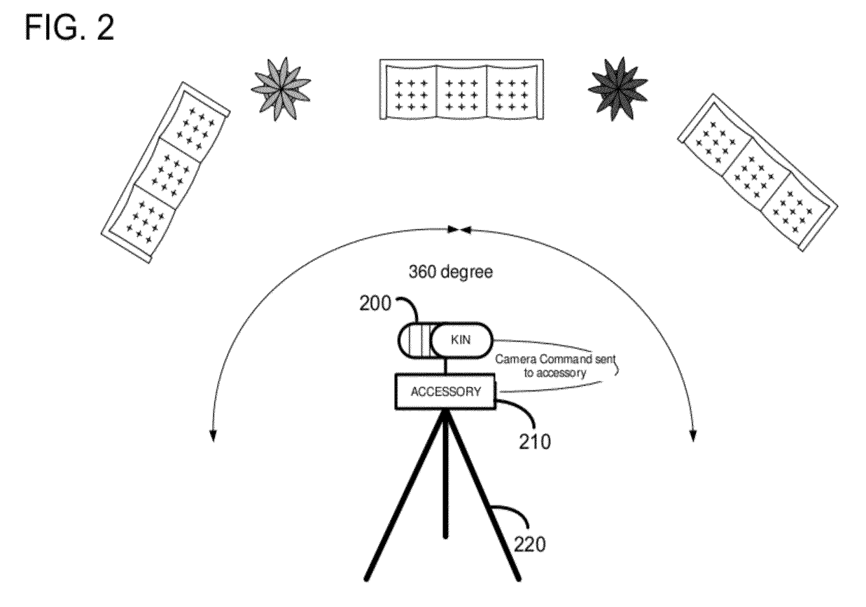

FIG. 2 shows an example of a system that can be used to track an object with a user-defined script. A camera 200 is coupled to a camera controller 210 (also called an accessory) through a cable or other means. The camera controller 210 is mounted to a tripod 220. The camera controller 210 can include a motor (not shown) that can rotate the camera through 360% of horizontal motion in response to the user-defined script. Vertical rotation of the camera can also be available. The camera controller 210 can further control any available feature on the camera, such as number of photos to take, time between photos, flash or not, zoom, and any other feature already mentioned above. As described further below, objects can be named and used in the user-defined script, such that the camera is directed to search its surroundings to find an object and then follow script instructions on how to further proceed in imaging and tracking the object.

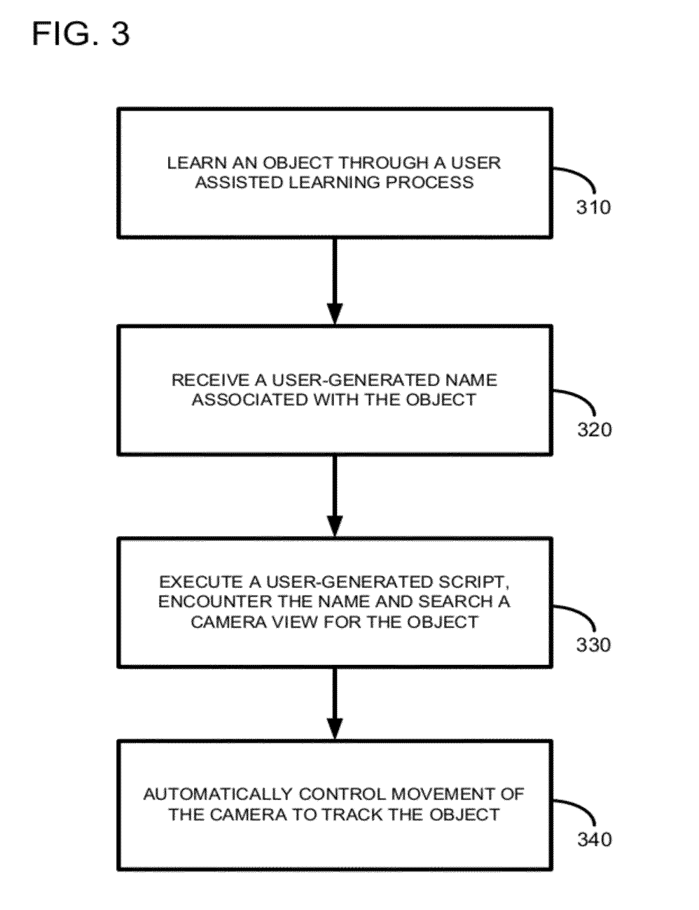

FIG. 3 is an example flowchart of a method for learning an object for automatic tracking. In process block 310, an object is learned through a user assisted learning process. For example, a user can enter the system into a learning mode wherein a picture can be taken of an object to be tracked. In one example, the user can place an object on a white background (or other known environment) and manually control an image to be taken by the camera. A computer-generated description can be created taking into consideration the color and shape of the object. The user can then enter a name to be associated with the computer-generated description (process block 320). For example, the user can capture an image of a football and the image can be passed to the camera controller for identification. A computer-generated description can be determined for the football. The user can enter “football” into a graphical user interface so that the computer-generated description of the football is associated with the word “football”. By associating a user-generated name with the computer description of the object, a user script can easily include the name with an instruction on how to image the object. For example, a command can request the camera to track the football or zoom in on football. Thus, in process block 330, a user-generated script can be executed. When a controller executing the script encounters a name, it can associate the name with the stored computer-generated description. A camera view can then be searched to see if objects in view have a shape that matches the shape of a stored computer-generated description. In process block 340, movement of the camera is automatically controlled to track the object that is detected in accordance with the script.

An example script is as follows:

<Find> <John> <in this room>
<if> <John> <not found> <within 3sec>
<find> <anyone> <or> <anything> <AND> <focus> <on> <for 2 sec>
<while> <filming>
<if> <Candle> <is found> <focus> <on> <while> <filming>

In the above script, a search is automatically performed for “John”, a tag name associated with a computer-generated description. If John is not found in a predetermined period of time (e.g., 3 seconds in this example), then the camera can choose an object to focus on for 2 seconds (or some other predetermined time). Pre-stored computer descriptions of objects can also be used. For example, a candle can have a computer description associated therewith. The script indicates that if a candle is found, it should be focused on by the camera. Thus, camera control can be based on an interpretation of the scene being imaged. Such interpretation is based on comparing imaged objects to computer-generated descriptions to find matches there between.

User actions can also be stored (such as waving hands) as computer descriptions so that when a user action is detected it can be treated like a script command and acted upon to control the camera. The same concept can be used for audio commands, which can be stored and detected.

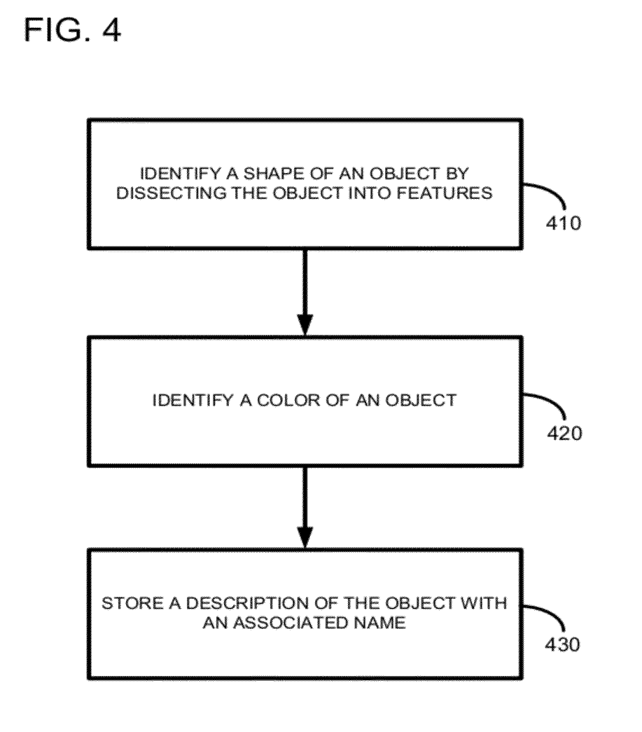

FIG. 4 is a flowchart of a method further expanding on the learning process. In process block 410, a shape is identified by dissecting the imaged object into features. For example, an outer edge of the imaged object can be detected and stored. In process block 420, a color of an imaged object can be matched to a color palette. The shape and color can be used as a computer description of the object. In process block 430, the computer description of the object is associated with a name or tag provided by the user. The name and description can be stored in a database for later use. For example, when a name is encountered in a script, the computer description can be compared against colors and shapes of objects being viewed by the camera.

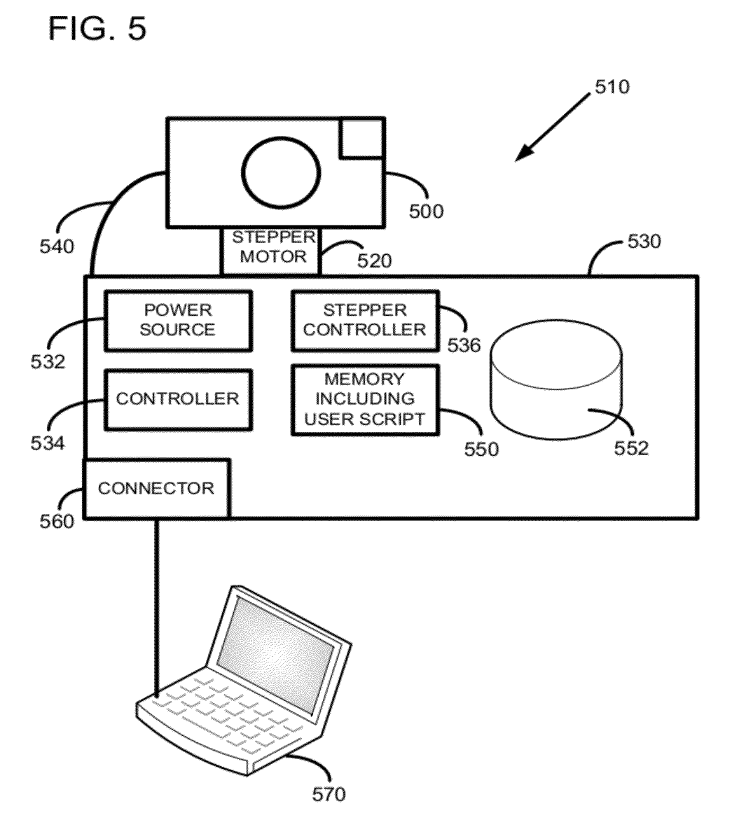

FIG. 5 is an example system wherein a camera 500 is automatically movable in a least a horizontal direction using a camera controller 510. The camera controller 510 can include a motor 520, such as a stepper motor, and control hardware 530. The particulars of the control hardware 530 can vary depending on the particular application. Internal wiring is not illustrated for clarity, but it is understood that the components in the control hardware are coupled together. The illustrated control hardware 530 includes a power source 532 for powering the system without the need for an external power supply. As can readily be appreciated, the camera 500 can more conveniently be positioned without a power cord. A controller 534 (e.g., signal processor, microprocessor, ASIC, or other control and processing logic circuitry) provides analysis and generates signals for a stepper controller circuit 536. The stepper controller circuit 536 is coupled to the stepper motor 520 and drives the motor in order to turn the camera in a desired direction. The controller 534 is also coupled to the camera through cable 540 in order to control features of the camera (zoom, flash, settings, etc.), as already indicated above. The controller can make intelligent decisions about tracking by executing a user script stored in a memory 550. Once a name is encountered in the script, the controller 534 searches a database 552 for an associated computer description of an object. The controller then receives view-finder data or an image from the camera and compares it to the computer description to identify the object. Once identified, the camera controller 534 can control the camera 500 and the stepper controller 536 in order to track the identified object in accordance with instructions in the script. Such control includes movement of the camera 500 as well as control of any desired camera features. Downloading the user script to the memory 550 can occur through connector 560, which can import the script from a computer 570 or other source. Also, pre-generated object descriptions (e.g., candle) can be downloaded to database 552 using the connector 560.

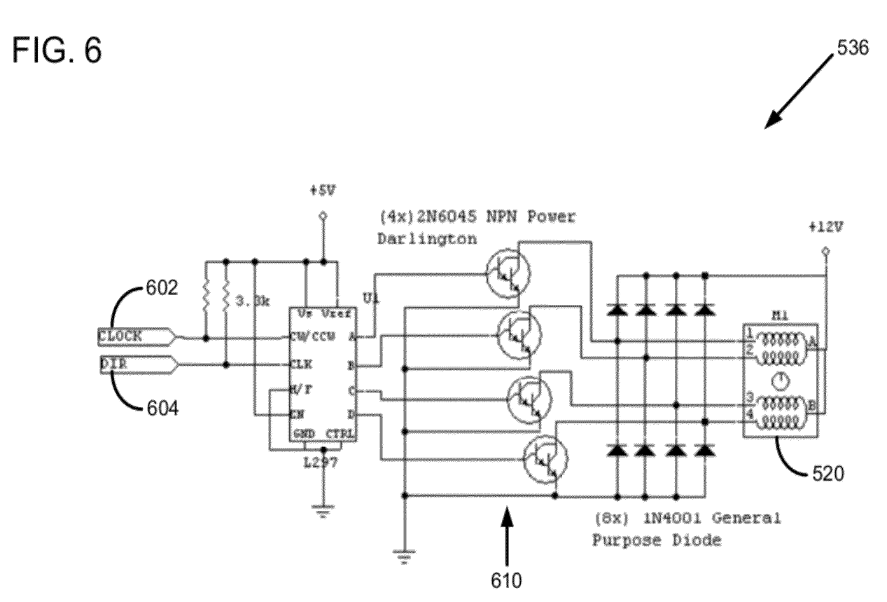

FIG. 6 shows an example stepper controller 536. An input clock 602 and direction signal 604 are received from the controller 534. ASICs available in the industry, such as the L297, can provide signals to parallel NPN transistors, which provide power to the motor for driving the motor in the indicated direction. Other circuits can be used.

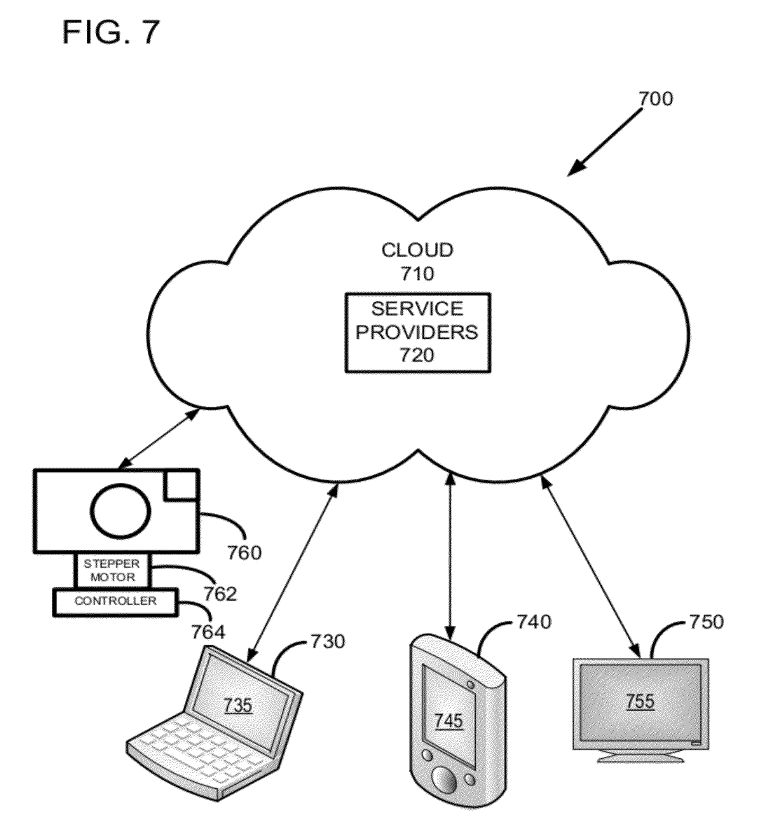

FIG. 7 illustrates a generalized example of a suitable implementation environment 700 in which described embodiments, techniques, and technologies may be implemented.

In example environment 700, various types of services (e.g., computing services) are provided by a cloud 710. For example, the cloud 710 can comprise a collection of computing devices 730, 740, 750, and 760, which may be located centrally or distributed, that provide cloud-based services to various types of users and devices connected via a network, such as the Internet. The implementation environment 700 can be used in different ways to accomplish computing tasks. For example, some tasks (e.g., processing user input and presenting a user interface) can be performed on local computing devices (e.g., connected devices 730, 740, 750, and 760) while other tasks (e.g., storage of data to be used in subsequent processing) can be performed in the cloud 710. One example is that the user script can be located in the cloud 710 and provided to the cloud by any of devices 730, 740, and 750. The cloud can then push the script to the camera system 760, which includes a step motor 762 and controller 764 for controlling the camera. The script can then be executed to control the camera as previously described.

In example environment 700, the cloud 710 provides services for connected devices 730, 740, 750, and 760 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touch screen capabilities.

In the example environment, the cloud 710 provides the technologies and solutions described herein using, at least in part, the service providers 720. For example, the service providers 720 can provide a centralized solution for various cloud-based services. The service providers 720 can manage service subscriptions for users and/or devices.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application).

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method for tracking an object using a camera, comprising:
providing a camera for taking still or video images; and
automatically controlling movement of the camera using a camera controller coupled to the camera, wherein an amount of movement is based on at least one user script provided by a user that describes a desired tracking of an object by the camera.

2. The method of claim 1, further including entering a learning mode wherein the object captured by the camera is passed to the camera controller for generating a computer description of the object.

3. The method of claim 2, further including receiving a user description that associates a name with the computer description of the object.

4. The method of claim 3, further including executing the user script, encountering the name in the script, and searching a camera view for the object.

5. The method of claim 4, wherein once the object is found, controlling movement of the camera to track the object based on the user script.

6. The method of claim 1, in a teaching mode of operation, receiving an image of the object and dissecting the object to interpret its features to generate a computer description.

7. The method of claim 6, further including identifying a color of the object.

8. The method of claim 1, further including automatically controlling a zoom of the camera based on the user script.

9. The method of claim 1, further including storing a computer description of the object and a name associated with the object, receiving an image of an object taken by the camera and comparing the object to the stored computer description to automatically identify the object.

10. The method of claim 1, further including receiving an instruction from the user script to wait for a predetermined period of time before moving the camera or controlling a camera zoom.

11. The method of claim 1, further including detecting a user action captured through an image and executing a command associated with the user action.

12. The method of claim 1, wherein the automatically controlling movement is in response to interpreting a scene and executing the user script in response to the scene.

13. An apparatus for tracking an object, comprising:
a camera for taking still or video images; and
a camera controller coupled to the camera for moving the camera in response to a user script provided by a user that describes a desired tracking of an object.

14. The apparatus of claim 13, wherein the camera controller includes at least one stepper motor responsive to a controller for moving the camera.

15. The apparatus of claim 13, further including a tripod upon which the camera controller is mounted.

16. The apparatus of claim 13, wherein the camera controller includes a memory for storing the user script, and a database used to store computer descriptions of objects.

17. A method for tracking an object using a camera, comprising:
learning at least one object during a learning mode in a camera controller to generate a computer description of the object;
receiving a user-defined name associated with the at least one object and storing the user-defined name in association with the computer description of the object;
receiving a user-defined script in the camera controller, the user-defined script including the user-defined name;
receiving an image from a camera coupled to the camera controller;
in response to the user-defined script, searching the image for the at least one object having the user-defined name and detecting the object by comparing it to the computer description of the object; and
if a match is found between the object and the computer description, automatically controlling movement of the camera using the camera controller to track the at least one object.

18. The method of claim 17, wherein an amount of movement is based on the user-defined script that describes a desired tracking of an object by the camera.

19. The method of claim 17, wherein learning includes placing the object in a known environment and detecting a shape of the object.

20. The method of claim 17, further including moving the camera in response to an audio signal.
